(19) United States
(12) Patent Application Publication
(10) Pub. No.: US 2015/0232595 A1
(43) Pub. Date: Aug. 20, 2015

(54) RESIN MIXTURE BASED ON VINYL ESTER RESIN, REACTIVE RESIN MORTAR COMPRISING SAME AND USE THEREOF

(71) Applicant: Hilti Aktiengesellschaft, Schaan (LI)

(72) Inventors: Michael Leitner, Landsbert (DE); Klaus Jaehnichen, Dresden (DE); Marcus Heinze, Dresden (DE); Brigitte Voit, Dresden (DE); Doris Pospiech, Dresden (DE)

(21) Appl. No.: 14/696,119

(22) Filed: Apr. 24, 2015

Related U.S. Application Data
(63) Continuation of application No. PCT/EP2013/072105, filed on Oct. 23, 2013.

(30) Foreign Application Priority Data
Oct. 26, 2012 (DE) 102012219652.8

(51) Int. Cl. C08F 220/18; C08K 3/00

(52) U.S. Cl. CPC C08F 220/18; C08K 3/0008; C08F 2220/1816

(57) ABSTRACT

Described is a resin mixture comprising a vinyl ester resin and a co-polymerizable compound, which bears at least two methacrylate groups, some of which is replaced by an itaconic acid ester. It is possible to control the properties of the composition, such as the curing, through the selection of the itaconic acid ester. In addition and beyond this feature, it is possible to formulate resin compositions that exhibit a certain amount of bio-based carbon.

### RELATED APPLICATIONS

This application claims priority to, and is a continuation of International Patent Application No. PCT/EP2013/072105 having an International filing date of Oct. 23, 2013, which is incorporated herein by reference, and which claims priority to German Patent Application No. 102012219652.8, having a filing date of Oct. 26, 2012, which are also incorporated herein by reference in their entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a resin mixture comprising a vinyl ester resin and a co-polymerizable compound, which bears at least two methacrylate groups, as the crosslinking agent.

The use of reactive resin mortars, based on radically curable compounds, as the binders has been known for a long time. In the field of fastening technology the use of resin mixtures as organic binders for the chemical fastening technology, for example, as a plugging compound, has proven successful. In this case it involves composite materials, which are formulated as multi component systems, wherein in this case one component contains the resin mixture and the other component contains the curing agent. Other conventional ingredients, such as solvents, including reactive solvents (reactive diluents), may be present in one component and/or the other component. Then the hardening reaction, i.e. the polymerization, is initiated through the formation of radicals, when the two components are mixed, and the resin is hardened to form the duromer. The radically curable compounds that are often used, in particular, for chemical fastening technology include vinyl ester resins and unsaturated polyester resins.

Vinyl ester resins, in particular, vinyl ester urethane resins, which can be obtained by means of monomeric or polymeric aromatic diisocyanates and hydroxyl-substituted methacrylates, such as hydroxyalkyl methacrylate, are used as the base resins due to their advantageous properties. EP 0713015 B1 describes, for example, plugging compounds with unsaturated polyester resins, vinyl ester resins, including vinyl ester urethane resins as the base resins. The compounds of such systems are based on the classical petroleum chemistry, in which the raw materials are obtained from fossil fuel sources, such as crude oil.

It is well-known that the fossil fuel sources, such as crude oil, are not inexhaustible and will eventually be depleted. In the event that the availability of fossil fuel sources decreases, there is the risk that the compounds that are essential to satisfy the high requirements imposed on the chemical fastening systems will no longer be obtainable.

Therefore, in the future there will be a need for alternative systems based on renewable resources with a high content of carbon from renewable resources, in order to continue in the future to be able to provide highly specialized chemical fastening systems.

Vinyl ester-based resin compositions, which contain methacrylate derivatives and itaconic acid esters as the reactive diluents, are known. WO 2010/108939 A1 describes a vinyl ester-based resin mixture with a reduced viscosity, which can be achieved by partially replacing the reactive diluent with an itaconic acid ester. The drawback with the described resin mixture is that the reactivity of the resin mixture and its complete hardening is not always guaranteed.

Hence, there is a need for a resin mixture that consists partially of constituents, which can be obtained on the basis of renewable resources and with which it is possible to control, as a function of the respective use, the storage stability and the reactivity of the resin mixture and the reactive resin mortars, which can be prepared from said resin mixture.

### BRIEF SUMMARY OF THE INVENTION

In one embodiment, the present resin mixture comprises a vinyl ester resin and a co-polymerizable monomeric compound, which bears two methacrylate groups, wherein the co-polymerizable compound is partially replaced by an itaconic acid ester of the general formula (I) or (II):

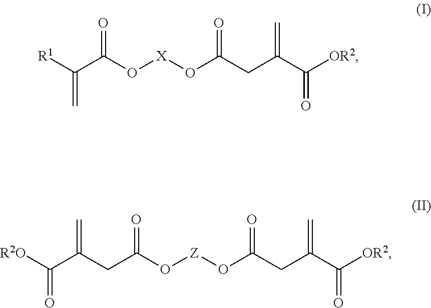

where R¹ stands for a hydrogen atom or a methyl group; R² stands for hydrogen or a C₁—C₆ alkyl group; X and Z stand, independently of each other, for a C₇—C₁₀ alkylene group.

In one example, the resin mixture can contain up to 100% by wt. of the co-polymerizable compound are replaced by the itaconic acid ester.

In another example, the itaconic acid ester of the formula (I) or (II) can be obtained completely from renewable resources. For example, the co-polymerizable compound can be one of 1,4-butanediol di(meth)acrylate, neopentyl glycol di(meth)acrylate, PEG di(meth)acrylate, triethylene glycol di(meth)acrylate and tripropylene glycol di(meth)acrylate).

In yet another example, the co-polymerizable compound, which bears two methacrylate groups, has an average molecular weight M⁻ₙ in the range of 200 to 500 g/mol.

In another example, the vinyl ester resin is contained in an amount of 20 to 100% by wt.; and the co-polymerizable compound, including the itaconic acid ester, is contained in an amount of 0 to 80% by weight in the resin mixture.

In another example, the resin mixture can also contain a polymerization inhibitor and an accelerator.

In one embodiment, the present reactive resin mortar comprises a resin mixture as discussed herein and at least one inorganic aggregate. For example, the inorganic aggregate can be fillers, thickeners, thixotropic agents, non-reactive solvents, agents for enhancing the ease of flow and/or wetting agents such as cement and/or quartz sand.

In one example, the inorganic aggregates are contained in an amount of 30 to 80% in the reactive resin mortar.

In one embodiment, the present multi-component mortar system comprises, as the A component, the reactive resin mortar, as discussed herein, and, as the B component, a hardener for the radically curable compound.

In one example, the A component also contains, in addition to the reactive resin mortar, additionally a hydraulically setting or polycondensable inorganic compound; and the B component also contains, in addition to the hardener, additionally water.

The multi-component mortar system can be used as a binder for chemical fastening.

### BRIEF DESCRIPTION OF SEVERAL VIEWS OF THE DRAWINGS

[Not Applicable]

### DETAILED DESCRIPTION OF THE INVENTION

The present engineering object can be achieved by means of a resin mixture and a reactive resin mortar as described and claimed herein.

One subject matter of the invention is a resin mixture comprising a vinyl ester resin and a co-polymerizable monomeric compound, which bears at least two methacrylate groups, as the crosslinking agent, wherein the co-polymerizable compound is partially or also completely replaced with an itaconic acid ester.

In accordance with the invention, vinyl ester resins are monomers, oligomers, prepolymers or polymers with at least one (meth)acrylate end group, so-called (meth)acrylate functionalized resins, which also include urethane (meth)acrylate resins and epoxy (meth)acrylates.

Vinyl ester resins that have unsaturated groups only in the end position, are obtained, for example, by reacting epoxy monomers, epoxy oligomers or epoxy polymers (for example, bisphenol-A-diglycidyl ether, epoxies of the phenol novolac type or epoxy oligomers based on tetrabromobisphenol A) with, for example, (meth)acrylic acid or (meth)acrylamide. Preferred vinyl ester resins are (meth)acrylate functionalized resins and resins that are obtained by reacting an epoxy monomer, an epoxy oligomer or an epoxy polymer with methacrylic acid or methacrylamide, preferably with methacrylic acid. Examples of such compounds are known from the patent applications U.S. Pat. No. 3,297,745 A, U.S. Pat. No. 3,772,404 A, U.S. Pat. No. 4,618,658 A, GB 2 217 722 A1, DE 37 44 390 A1 and DE 41 31 457 A1.

The vinyl ester resins that are particularly suitable and preferred are (meth)acrylate functionalized resins, which are obtained, for example, by reacting diisocyanate and/or higher functional isocyanates with suitable acrylic compounds, optionally with the cooperation of hydroxy compounds, which comprise at least two hydroxyl groups, as described, for example, in DE 3940309 A1.

Aliphatic (cyclic or linear) and/or aromatic diisocyanate or higher functional isocyanates or prepolymers thereof may be used as the isocyanates. The use of such compounds serves to increase the wetting power and, thus, to improve the adhesive properties. Preferred are aromatic diisocyanate or higher functional isocyanates or prepolymers thereof, where in this case the aromatic dipolymers or higher functional prepolymers are particularly preferred. Some examples that can be mentioned are toluene diisocyanate (TDI), diisocyanatodiphenylmethane (MDI) and polymeric diisocyanatodiphenylmethane (pMDl) to increase the chain stiffness and hexane diisocyanate (HDI) and isophorone diisocyanate (IPDI), all of which improve the flexibility, where in this case the polymeric diisocyanatodiphenylmethane (pMDl) is even more highly preferred.

The acyl compounds that are suitable include acrylic acid and those acrylic acids, which are substituted at the hydrocarbon radical, such as methacrylic acid, hydroxyl group containing esters of acrylic acid or methacrylic acid with polyhydric alcohols, pentaerythritol tri(meth)acrylate, glycerol di(meth)acrylate, such as trimethylolpropane di(meth)acrylate, neopentyl glycol mono(meth)acrylate. Preferred are acrylic or methacrylic acid hydroxylalkyl esters, such as hydroxyethyl (meth)acrylate, hydroxypropyl (meth)acrylate, polyoxyethylene (meth)acrylate, polyoxypropylene (meth)acrylate, especially those compounds that are used to sterically hinder the saponification reaction.

Optionally useable hydroxy compounds that lend themselves well include dihydric or polyhydric alcohols, such as the reaction products of the ethylene oxide or propylene oxide, such as ethanediol, diethylene glycol or triethylene glycol, propanediol, dipropylene glycol, other diols, such as 1,4-butanediol, 1,6-hexanediol, neopentyl glycol, diethanolamine, furthermore, bisphenol A or F or their ethoxylation products/propoxylation products and/or hydrogenation products or halogenation products, polyhydric alcohols, such as glycerol, trimethylolpropane, hexanetriol and pentaerythritol, hydroxyl group-containing polyethers, for example, oligomers of aliphatic or aromatic oxiranes and/or higher cyclic ethers, such as ethylene oxide, propylene oxide, styrene oxide and furan, polyethers which contain aromatic structural units in the main chain, such as those of bisphenol A or F, hydroxyl group-containing polyesters based on the aforementioned alcohols or polyethers and dicarboxylic acids or the anhydrides thereof, such as adipic acid, phthalic acid, tetra- or hexahydrophthalic acid, HET acid [chlorendic acid], maleic acid, fumaric acid, itaconic acid, sebacic acid and the like. Particularly preferred are hydroxyl compounds with aromatic structural units for stiffening the chain of the resin, hydroxy compounds, which comprise unsaturated structural units, such as fumaric acid, to increase the crosslink density, branched or star-shaped hydroxy compounds, especially trihydric or polyhydric alcohols and/or polyethers or polyesters, which contain their structural units, branched or star-shaped urethane (meth)acrylates to achieve a lower viscosity of the resins or more specifically their solutions in reactive diluents and to achieve a higher reactivity and crosslink density.

The vinyl ester resin has preferably a molecular M⁻ₙ in the range of 500 to 3,000 Dalton, even more highly preferred 500 to 1,500 Dalton (according to ISO 13885-1). The vinyl ester resin has an acid value in the range of 0 to 50 mg of KOH/g of resin, preferably in the range of 0 to 30 mg of KOH/g of resin (according to ISO 21 14-2000).

All of these resins, which may be used according to the invention, can be modified in accordance with methods that are known to the person skilled in the art, in order to achieve, for example, lower acid numbers, hydroxide numbers or anhydride numbers, or to be made more flexible by the incorporation of flexible units in the backbone, and the like.

In addition and beyond this feature, the resin may also comprise other reactive groups that can be polymerized with a radical initiator, such as peroxides, for example, reactive groups, which are derived from itaconic acid, citraconic acid and allylic groups, and the like.

The base resins are used in an amount of 20 to 100% by wt., preferably 50 to 70% by wt., based on the resin mixture.

According to the invention, the resin mixture contains at least one co-polymerizable compound having at least two (meth)acrylate groups as the crosslinking agent, where in this case said crosslinking agent(s) can be added in an amount of 0 to 80% by wt., preferably 30 to 50% by wt., based on the resin mixture.

The co-polymerizable compound, which bears at least two methacrylate groups, has preferably an average molecular weight M⁻n in the range of 200 to 500 g/mol.

Suitable co-polymerizable compounds are selected from the group consisting of 1,4-butanediol di(meth)acrylate, 1,3-butanediol di(meth)acrylate, 2,3-butanediol di(meth)acrylate, 1,6-hexanediol di(meth)acrylates and its isomers, neopentyl glycol di(meth)acrylate, diethylene glycol di(meth)acrylates, triethylene glycol di(meth)acrylates, glycerol di(meth)acrylate, PEG di(meth)acrylates, such as PEG200 di(meth)acrylate, triethylene glycol di(meth)acrylate and tripropylene glycol di(meth)acrylate, trimethylolpropane di(meth)acrylate, dipropylene glycol di(meth)acrylate, tripropylene glycol di(meth)acrylate, PPG di(meth)acrylates, such as PPG250 di(meth)acrylate, 1,10-decanediol di(meth)acrylate and/or tetraethylene glycol di(meth)acrylate.

Preferred is the co-polymerizable compound having at least two (meth)acrylate groups selected from the groups consisting of 1,4 butanediol di(meth)acrylate, neopentyl glycol di(meth)acrylate, PEG 200 di(meth)acrylate, triethylene glycol di(meth)acrylate and/or tripropylene glycol di(meth)acrylates.

According to the invention, the co-polymerizable compound having at least two (meth)acrylate groups is replaced by one or more of the itaconic acid esters described below, where in this case up to 100% by wt. may be replaced by the co-polymerizable compound.

The itaconic acid and their ester derivatives have been identified as valuable chemicals, which can be obtained from biomass. Therefore, these compounds lend themselves well, as a general principle, as the starting compound based on renewable resources.

The inventors could show that it is possible to provide the constituents for the binders on this basis, where the constituents have no negative effect on the properties of the binder, either with respect to the curing properties or with respect to the properties of the cured compositions, even though it is known that the itaconic acid and the esters thereof generally polymerize slower than the methacrylic acid esters under the same conditions. Instead, it could be demonstrated that it is possible to control the properties of the binders, based on vinyl ester resin, in a targeted way with compounds, based on itaconic acid.

According to the invention, the itaconic acid ester is a compound of the general formula (I) or (II)

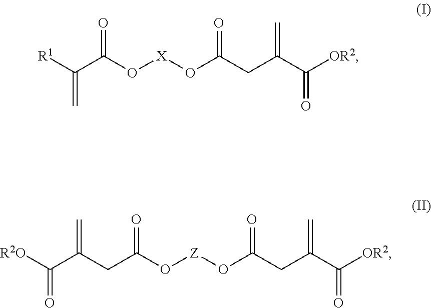

where R¹ stands for a hydrogen atom or a methyl group; R² stands for hydrogen or a C₁—C₆ alkyl group; X and Z stand, independently of each other, for a C₇—C₁₀ alkylene group.

The compounds of the formula (I) can be obtained, for example, by reacting itaconic acid hydride with hydroxy-substituted (meth)acrylates, so that compounds with a terminal carboxyl group and two radically polymerizable carbon to-carbon double bonds are obtained.

The hydroxyl-substituted (meth)acrylates can be obtained from renewable resources and are, therefore, of particular interest in the formulation of resin mixtures, which are based, as much as possible, on ingredients based on renewable resources.

In this case said hydroxy-substituted (meth)acrylates involves aliphatic C₂—C₁₀-hydroxyalkyl (meth)acrylates, such as hydroxypropyl (meth)acrylate or hydroxyethyl (meth)acrylate, of which special preference is given to the methacrylate compounds.

The propylene glycol, which is required for the synthesis of, for example, the preferred hydroxypropyl methacrylate, may be obtained from glycerol (CEPmagazine.org, www.aiche.org/cep (August 2007), in the article “A Renewable Route to Propylene Glycol” by Suzanne Shelley). Glycerol is an essential by product in the production of biodiesel. Thus, it is an inexpensive, sustainable and environmentally friendly alternative to the conventional raw material, which is derived from petroleum, for the preparation of propylene glycol.

Ethylene glycol, which is required for the synthesis of hydroxyethyl methacrylate, can also be obtained from raw materials, such as ethylene oxide and derivatives thereof, such as glycols, which can be obtained from biomass, such as molasses or sugar cane.

The C₂- and C₃-hydroxyalkyl methacrylates are available on the market.

The inventors have found that storage stable resin mixtures are obtained with itaconic acid esters of the formula (I), only if the terminal carboxyl group of the itaconic acid ester is esterified with the corresponding alcohols.

Therefore, R² in formula (I) is preferably a C₁—C₆ alkyl group and even more highly preferred a methyl group or an ethyl group, where in this case the methyl group is the most highly preferred. These compounds can also be obtained from renewable resources, where in this case, for example, methanol and ethanol can be obtained from biomass.

The compounds of the formula (II) can be obtained by reacting approximately two times the amount of itaconic acid anhydride with diols, where in this case compounds with two terminal carboxyl groups and two radically polymerizable carbon to-carbon double bonds are obtained.

The diols can be obtained from renewable resources and are, therefore, of particular interest in the formulation of resin mixtures that are based, as much as possible, on ingredients based on renewable resources. As a result, said diols involve, according to the invention, aliphatic C₂—C₁₀ alkane diols, such as ethylene glycol, 1,2-propanediol, 1,3-propanediol, 1,2-butanediol, 1,4-butanediol, 1,5-pentanediol, 2,4-dimethyl-2-ethylhexane-1,3-diol, 2,2-dimethyl-1,3-propanediol, 2-ethyl-2-butyl-1,3-propanediol, 2-ethyl-2-isobutyl-1,3-propanediol, 2,2,4-trimethyl-1, 6-hexanediol, in particular, ethylene glycol, 1,3-propanediol, 1,4-butanediol, and 2,2-dimethyl-1,3-propanediol (neopentyl glycol).

The use of C₂—C₁₀ alkane diols has the advantage that it can be obtained from the basic building blocks C-2 to C-10 of vegetable origin. The preferred 1,3-propanediol can be obtained, for example, from glycerol by means of biotechnological methods. Glycerol is obtained as a constituent of all vegetable oils, for example, as a by-product in the preparation of fatty acids and in the production of biodiesel.

In this case, too, it was observed that storage stable resin mixtures are obtained with itaconic acid esters of the formula (II), only if the terminal carboxyl groups of the di itaconic acid ester are esterified with the corresponding alcohols.

Therefore, R² even in formula (II) is preferably a C₁—C₆ alkyl group and even more highly preferred a methyl group or an ethyl group, where in this case the methyl group is the most highly preferred. These compounds can also be obtained from renewable resources, where in this case, for example, methanol and ethanol can be obtained from biomass.

Thus, the itaconic acid esters of the general formulas (I) and (II) can be obtained completely from renewable resources.

The most highly preferred are itaconic acid esters of the general formula (I), where in this case R¹ and R² denote a methyl group. It is possible to use these itaconic acid esters to prepare resin mixtures that are both stable in storage and have a higher reactivity, compared to the itaconic acid esters, which have only itaconic acid double bonds, and that exhibit faster curing, compared to compounds with terminal carboxyl groups.

In addition to the co-polymerizable compounds having at least two (meth)acrylate groups as a crosslinking agent, the resin mixture may also comprise additional low viscosity co-polymerizable compounds having a (meth)acrylate group as the reactive diluents. Suitable reactive diluents are described in EP 1 935 860 A1 and DE 195 31 649 A1.

In principle, other conventional reactive diluents may also be used, alone or in admixture with (meth)acrylic acid esters, for example, styrene, alpha-methyl styrene, alkylated styrenes, such as tert-butyl styrene, divinyl benzene, vinyl ethers and/or allyl compounds.

According to an additional preferred embodiment of the invention, the resin mixture is present in the pre-accelerated form. That is, it contains at least one accelerator for the curing agent. Preferred accelerators for the curing agent are aromatic amines and/or salts of cobalt, manganese, tin, vanadium or cerium. Anilines, p- and m-toluidine and xylidines, which are substituted symmetrically or asymmetrically with alkyl radicals or hydroxyalkyl radicals, have proven to be especially advantageously as an accelerator. Some example that may be mentioned include the following preferred accelerators: N,N-dimethylaniline, N,N-diethylaniline, N,N-diethylolaniline, N-ethyl-N-ethylolaniline, N,N-diisopropanol-p-toluidine, N,N-diisopropylidene-p-toluidine, N,N-dimethyl-p-toluidine, N,N-diethylol-p-toluidine, N,N-diethylol-m-toluidine, N,N-diisopropylol-m-toluidine, N,N-bis(2-hydroxyethyl)toluidine, N,N-bis(2-hydroxyethyl)xylidine, N-methyl-N-hydroxyethyl-p-toluidine, cobalt octoate, cobalt naphthenate, vanadium(IV) acetylacetonate and vanadium(V) acetylacetonate.

The accelerator or more specifically the accelerator mixture is used, according to the invention, in an amount of 0.05 to 5% by wt., preferably 1 to 2% by wt., based on the resin mixture.

In an additional embodiment of the invention, the resin mixture further comprises, furthermore, at least one more polymerization inhibitor in order to ensure stability in storage and in order to adjust the gel time. According to the invention, polymerization inhibitors that are suitable include polymerization inhibitors, which are commonly used for radically polymerizable compounds, in particular, those known to the person skilled in the art. Preferably the polymerization inhibitors are selected from phenolic compounds and non-phenolic compounds, such as stable radicals and/or phenothiazines.

Suitable phenolic inhibitors, which are often a constituent of commercial, radically curing reactive resins, include phenols, such as 2-methoxyphenol, 4-methoxyphenol, 2,6-di-tert-butyl-4-methylphenol, 2,4-di-tert-butylphenol, 2,6-di-tert-butylphenol, 2,4,6-trimethylphenol, 2,4,6-tris(dimethylaminomethyl)phenol, 4,4′-thio-bis(3-methyl-6-tert-butylphenol), 4,4′-isopropylidenediphenol, 6,6′-di-tert-butyl-4,4′-bis(2,6-di-tert-butylphenol), 1,3 ,5-trimethyl-2,4,6-tris(3,5-di-tert-butyl-4-hydroxybenzyl)benzene, 2,2′-methylene-di-p-cresol, pyrocatechol and butyl pyrocatechols, such as 4-tert-butyl pyrocatechol, 4,6-di-tert-butylpyrocatechol, hydroquinones, such as hydroquinone, 2-methyl hydroquinone, 2-tert-butylhydroquinone, 2,5-di-tert-butylhydroquinone, 2,6-di-tert-butylhydroquinone, 2,6-dimethylhydroquinone, 2,3,5-trimethylhydroquinone, benzoquinone, 2,3,5,6-tetrachloro-1,4-benzoquinone, methyl benzoquinone, 2,6-dimethylbenzoquinone, naphthoquinone, or mixtures of two or more thereof.

Said phenol inhibitors have, based on the reactive resin formulation, preferably a content of up to 1% by wt., in particular between 0.0001 and 0.5% by wt., for example, between 0.01 and 0.1% by wt.

Suitable non-phenolic polymerization inhibitors may include preferably phenothiazines, such as phenothiazine and/or derivatives or combinations thereof, or stable organic free radicals, such as galvinoxyl and N-oxyl radicals.

For example, those N-oxyl radicals, which are described in DE 199 56 509, may be used as the N-oxyl radicals. Suitable stable N-oxyl radicals (nitroxyl radicals) may be selected from 1-oxyl-2,2,6,6-tetramethylpiperidine, 1-oxyl-2,2,6,6-tetramethylpiperidine-4-ol (also referred to as TEMPOL), 1-oxyl-2,2,6,6-tetramethylpiperidine-4-one (also referred to as TEMPON), 1-oxyl-2,2,6,6-tetramethyl-4-carboxyl-piperidine (also referred to as 4-carboxy-TEMPO), 1-oxyl-2,2,5,5-tetramethylpyrrolidine, 1-oxyl-2,2,5,5-tetramethyl-3-carboxylpyrrolidine (also referred to as 3-carboxy-PROXYL), aluminum-N-nitrosophenylhydroxylamine, diethyl hydroxylamine. Furthermore, suitable N-oxyl compounds are oximes, such as acetaldoxime, acetone oxime, methyl ethyl ketoxime, salicyloxime, benzoxime, glyoximes, dimethylglyoxime, acetone-O-(benzyloxycarbonyl)oxime and the like.

The polymerization inhibitors may be used, depending on the desired properties of the resin compositions, either alone or as a combination of two or more thereof. In this case the combination of phenolic and non-phenolic polymerization inhibitors enables a synergistic effect, which is also demonstrated by the adjustment of a more or less drift free setting of the gelling time of the reactive resin formulation.

The percentage by weight of the non-phenolic polymerization inhibitors is preferably in the range of 1 ppm to 2% by wt., preferably in the range of 10 ppm to 1% by wt., based on the reactive resin formulation.

The inventive resin mixtures are used to prepare reactive resin mortars for the chemical fastening technology.

Therefore, an additional subject matter of the invention is a reactive resin mortar, which comprises, in addition to the resin mixture, conventional inorganic aggregates, such as fillers, thickeners, thixotropic agents, non-reactive solvents, agents to enhance the ease of flow and/or wetting agents. The fillers are selected preferably from the group, comprising particles of quartz, vitreous fused silica, corundum, calcium carbonate, calcium sulfate, glass and/or organic polymers of variable size and shape, for example as sand or flour, in the form of spheres or hollow spheres, but also in the form of fibers of organic polymers, such as, for example, polymethyl methacrylate, polyester, polyamide or also in the form of microspheres from polymers (bead polymerzates).

However, the globular, inert substances (spherical shape) are preferred due to their significantly higher reinforcing effect.

The inorganic aggregates may be present in an amount of 30 to 80% in the reactive resin mortar.

The preferred thickeners or thixotropic agents are those based on silicates, bentonite, laponite, pyrogenic silicic acid, polyacrylates and/or polyurethanes.

Yet another subject matter of the invention is a multi-component mortar system, which comprises at least two (spatially) separate components A and B. The multi component mortar system comprises two or more separate, interconnected and/or nested containers, where in this case the one container contains the component A, the reactive resin mortar; and the other container contains the component B, the hardener, which may or may not be filled with inorganic and/or organic aggregates.

The multi component mortar system may be present in the form of a capsule, a cartridge or a plastic bag. When the inventive reactive resin mortar is used as intended, the component A and the component B are pressed out of the capsules, cartridges or plastic bags by either applying mechanical forces or subject to the action of a gas pressure and then mixed with one another, preferably by means of a static mixer, through which the constituents are passed, and then introduced into the borehole. Thereafter, the devices, such as threaded anchor rods and the like, which are to be fastened, are inserted into the borehole, which is filled with the reactive resin that cures, and are then suitably adjusted.

Preferred hardeners are organic peroxides that are stable in storage. In particular, dibenzoyl peroxide and methyl ethyl ketone peroxide, furthermore, tert-butyl perbenzoate, cyclohexanone peroxide, lauroyl peroxide and cumene hydroperoxide, as well as tert-butylperoxy 2-ethylhexanoate are quite suitable.

In this context the peroxides are used in amounts of 0.2 to 10% by wt., preferably from 0.3 to 3% by wt., based on the reactive resin mortar.

In an especially preferred embodiment of the multi component mortar system of the invention, the A component also comprises, in addition to the curable constituent (a), a hydraulically setting or polycondensable inorganic compound, in particular, cement; and the B component also comprises water, in addition to the curing agent. Such hybrid mortar systems are described in detail in DE 42 31 161 A1. In this respect the A component contains preferably cement, for example, Portland cement or aluminate cement, as the hydraulically setting or polycondensable inorganic compound, where in this case cements that contain no iron oxide or have a reduced iron oxide content are even more highly preferred. Gypsum can also be used as such or in admixture with the cement as the hydraulically setting inorganic compound.

The A component may also comprise substances containing silicious, polycondensable compounds, in particular, soluble, dissolved and/or amorphous silicon dioxide, as the polycondensable inorganic compound.

The advantage of the invention lies in the fact that the curing properties of the resin mixture or more specifically of the reactive resin mortar containing said resin mixture can be influenced by the choice of the corresponding itaconic acid esters. Moreover, it could be demonstrated that it is possible to replace some of a conventional petrochemistry based resin mixture and, as a result, some of this reactive resin mortar containing said resin mixture with bio based components, without adversely affecting the properties of the reactive resin mortar.

The following examples serve to explain the invention in more detail.

### EXAMPLES

### Example 1

The following resin mixture is prepared as a reference resin in accordance with EP 0713015 B1.

60 g of the isomeric mixture of diphenylmethane diisocyanate are introduced at 25 deg. C. Following addition of 0.03 ml of dibutyl tin dilaurate, 7 g of dipropylene glycol are added dropwise. During the addition the internal temperature rises, subject to slight concurrent heating, to 55 deg. C. Then said mixture is stirred for 30 minutes at 55 deg. C. Thereafter 80 g of hydroxypropyl methacrylate (HPMA) are added dropwise. The internal temperature rises subject to a slight concomitant heating to 95 deg. C. Then the batch will be stirred for another two hours at 95 deg. C, until the residual NCO content is below 0.2%, as determined in accordance with DIN EN 1242. Then 80 g of 1,4-butanediol dimethacrylate are added as a comonomer. Finally 0.1 g of phenothiazine, 1 g of tert-butyl pyrocatechol and 7 g of diisopropanol p toluidine are added as the accelerator.

### Example 2

The resin mixture is produced in a manner analogous to Example 1 with the difference that, instead of 80 g of 1,4-butanediol dimethacrylate as the comonomer, a comonomer mixture consisting of 40 g of 1,4-butanediol dimethacrylate and 40 g of 4-(2-(methacryloyloxy)ethyl)-1-methyl-2-methylene succinate (formula I: X═—CH₂—CH₂—, R¹═CH₃, R²═CH₃) is produced.

### Example 3

The resin mixture is produced in a manner analogous to Example 1 with the difference that, instead of 80 g of 1,4-butanediol dimethacrylate as the comonomer, a comonomer mixture consisting of 40 g of 1,4-butanediol dimethacrylate and 40 g of 1-dimethyl-O′4,04-propane-1,3-diyl-bis(2-methylene succinate) (formula II: Z═—CH₂—CH₂—CH₂—, R²═CH₃) is produced.

Preparation of the Reactive Resin Mortar

In order to prepare the hybrid mortar, the resin mixtures from the Examples 1 to 3) are mixed with 30 to 45 percent by weight of quartz sand, 15 to 25 percent by weight of cement and 1 to 5 percent by weight of pyrogenic silicic acid in a dissolver to form a homogeneous mortar composition.

Hardener Component

In order to prepare the hardener component, 40 g of dibenzoyl peroxide, 250 g of water, 25 g of pyrogenic silicic acid, 5 g of phyllosilicate and 700 g of quartz powder of suitable particle size distribution are mixed in the dissolver to form a homogeneous composition.

The respective reactive resin mortar and the hardener component are mixed together in a volumetric ratio of 5:1; and their bond load capacity is measured.

Determination of the Failure Bond Stresses

In order to determine the failure bond stress of the cured composition, threaded anchor rods M12, which are doweled into holes in concrete with a diameter of 14 mm and a hole depth of 72 mm with the reactive resin mortar compositions of the examples, are used. In this case the holes were well cleaned, hammer drilled boreholes; the curing was always carried out at 20 deg. C. The mean failure loads are determined by extracting the threaded anchor rods in a concentric manner. In each case five threaded anchor rods are dowelled in; and after 24 hours of hardening, their load values are determined. The bond load capacities σ (N/mm2), determined in this way, are shown as the mean value in Table 1 below.

TABLE 1

| | Example 1 | Example 2 | Example 3 |
|---|---|---|---|
| Bond load capacity | 24.5 ± 1.3 | 21.6 ± 1.6 | 19.2 ± 0.9 |
| [N/mm²] | | | |

Commercially available products having very high bond load capacities, such as, for example, HIT HY200A from the company Hilti, achieve values of about 30 N/mm² under comparable conditions. As a result, it shows that the tested prototypes, based on the examples 2 to 3, have a promising load profile.

1. A resin mixture comprising
a vinyl ester resin and
a co-polymerizable monomeric compound having two methacrylate groups, wherein the co-polymerizable compound is partially replaced by an itaconic acid ester of the general formula (I) or (II): 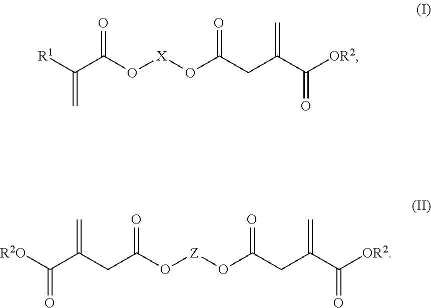
where R¹ stands for a hydrogen atom or a methyl group; R² stands for hydrogen or a C₁—C₆ alkyl group; X and Z stand, independently of each other, for a C₇—C₁₀ alkylene group.

2. The resin mixture of claim 1 wherein up to 100% by wt. of the co-polymerizable compound is replaced by the itaconic acid ester.

3. The resin mixture of claim 1 wherein the itaconic acid ester of the formula (I) or (II) can be obtained completely from renewable resources.

4. The resin mixture of claim 1 wherein the co-polymerizable compound having two methacrylate groups has an average molecular weight M⁻ₙ in the range of 200 to 500 g/mol.

5. The resin mixture of claim 1 wherein the co-polymerizable compound is selected from the group consisting of 1,4 butanediol di(meth)acrylate, neopentyl glycol di(meth)acrylate, PEG di(meth)acrylate, triethylene glycol di(meth)acrylate and tripropylene glycol di(meth)acrylate).

6. The resin mixture of claim 1 wherein the vinyl ester resin is contained in an amount of 20 to 100% by wt.; and the co-polymerizable compound, including the itaconic acid ester, is contained in an amount of 0 to 80% by weight in the resin mixture.

7. The resin mixture of claim 1 further comprising a polymerization inhibitor and an accelerator.

8. A reactive resin mortar comprising the resin mixture of claim 1 and at least one inorganic aggregate.

9. The reactive resin mortar of claim 8 wherein said at least one inorganic aggregate is selected from the group consisting of fillers, thickeners, thixotropic agents, non-reactive solvents, agents for enhancing the ease of flow and wetting agents.

10. The reactive resin mortar of claim 9 wherein said at least one inorganic aggregate is cement, quartz sand or a mixture thereof.

11. The reactive resin mortar of claim 8 wherein the inorganic aggregates are contained in an amount of 30 to 80% in the reactive resin mortar.

12. A multi-component mortar system comprising a first component containing the reactive resin mortar of claim 8 and a second component containing a hardener for a radically curable compound.

13. The multi-component mortar system of claim 12 wherein the first component further contains a hydraulically setting or polycondensable inorganic compound; and the second component further contains water.

14. Use of the multi component mortar system of claim 12 as a binder for chemical fastening.
